(19) United States
(12) Patent Application Publication
(10) Pub. No.: US 2009/0245399 A1
(43) Pub. Date: Oct. 1, 2009

(54) METHOD AND APPARATUS FOR INSERTING GUARD INTERVAL IN A MOBILE COMMUNICATION SYSTEM

(76) Inventors: Jung Hoon Lee, Seoul (KR); Eun Sun Kim, Seoul (KR); Bong Hoe Kim, Gyeonggi-do (KR); Young Woo Yun, Seoul (KR); Dong Youn Seo, Seoul (KR); Ki Jun Kim, Seoul (KR); Suk Hyon Yoon, Seoul (KR); Joon Kui Ahn, Seoul (KR); Hak Seong Kim, Seoul (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/297,612

(22) PCT Filed: Apr. 20, 2007
(86) PCT No.: PCT/KR2007/001940

§ 371 Date: Mar. 13, 2009

(30) Foreign Application Priority Data
Apr. 20, 2006 (KR) 10-2006-0035839

(51) Int. Cl. H04L 27/28

(52) U.S. Cl. 375/260

(57) ABSTRACT

A method for inserting a guard interval in an OFDM or OFDMA mobile communication system and a transmitting apparatus therefore are disclosed. The method for inserting a guard interval in an OFDM or OFDMA mobile communication system comprises rotating a phase of each symbol for a specific symbol stream, converting the phase-rotated symbol stream into a time-domain symbol stream, and performing at least one of copying a rear part of the time-domain symbol stream to insert the rear part of the time-domain symbol stream to the front of the time-domain symbol stream and copying a front part of the time-domain symbol stream to insert the front part of the time-domain symbol stream to the end of the time-domain symbol stream.

### TECHNICAL FIELD

The present invention relates to a communication system, and more particularly, to a method for inserting a guard interval in an orthogonal frequency division multiplexing (OFDM) or orthogonal frequency division multiple access (OFDMA) mobile communication system and a transmitter thereof.

### BACKGROUND ART

The basic principle of orthogonal frequency division multiplexing (OFDM) is to divide a data stream having a high data transmission rate into a plurality of data streams having a low data transmission rate and simultaneously transmit the data streams by using multiple carriers. In this case, each of the multiple carriers is referred to as a sub-carrier. Since orthogonality exists among the plurality of sub-carriers, a receiving side can detect frequency components of the carriers even if the respective frequency components are overlapped with each other. The data stream having a high data transmission rate is converted into a plurality of data streams having a low data transmission rate through a serial to parallel converter. The converted data streams are multiplied by each of the sub-carriers, and the respective data streams are added to each other, whereby the resultant data streams are transmitted to the receiving side.

OFDMA is a multiple access scheme which realizes multiple access by providing each user with some of sub-carriers that can be used in an OFDM modulation system. OFDMA provides frequency resources corresponding to sub-carriers to each user, wherein the respective frequency resources are independently provided to a plurality of users and thus are not overlapped with each other. After all, the frequency resources are assigned exclusively.

The plurality of parallel data streams generated by the serial to parallel converter can be transmitted with a plurality of sub-carriers by inverse discrete fourier transform (IDFT). The IDFT can be realized efficiently using inverse fast fourier transform (IFFT).

Since symbol duration of a sub-carrier having a low data transmission rate increases, temporally relative signal dispersion generated by multi-path delay spread is reduced. Meanwhile, a guard interval longer than delay spread of a channel may be inserted between OFDM symbols to reduce inter-symbol interference. Also, if a part of an OFDM signal is copied in the guard interval and arranged therein, the OFDM symbol is cyclically extended to be guarded.

The guard interval may be arranged at either a start part of the symbol or an end part of the symbol. If the guard interval is arranged at the start part of the symbol, it is referred to as cyclic prefix. If the guard interval is arranged at the end part of the symbol, it is referred to as cyclic postfix. The cyclic prefix and the cyclic postfix may be used independently or together depending on the system.

FIG. 1 is a diagram for illustrating a method of inserting the cyclic prefix and the cyclic postfix in case where both the cyclic prefix and the cyclic postfix are used in accordance with the related art. In FIG. 1, a part ‘A’ represents a portion where a data stream to be transmitted is converted into time-domain signals by IFFT. The cyclic prefix is generated in such a manner that a rear part ‘B’ of the part ‘A’ is copied and arranged in front of the part ‘A.’ The cyclic postfix is generated in such a manner that a front part ‘C’ of the part ‘A’ is copied and arranged at the back of the part ‘A.’

In other words, in order that both the cyclic prefix and the cyclic postfix are used, inconvenience occurs in that double copying and inserting operations are required for each symbol after IFFT is performed for the data stream to be transmitted. This could lead to a main factor that may deteriorate efficiency of the overall system.

### DISCLOSURE OF THE INVENTION

Accordingly, the present invention is directed to a method for inserting a guard interval in a mobile communication system and a transmitter, which substantially obviate one or more problems due to limitations and disadvantages of the related art.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

An object of the present invention is to provide a method and apparatus for inserting a guard interval in an OFDM or OFDMA mobile communication system by using a method which is simpler and more efficient than a related art method.

Another object of the present invention is to provide a method and apparatus for inserting a guard interval for a radio frame which includes a plurality of symbols having different sized guard intervals.

Still another object of the present invention is to provide a method and apparatus for inserting a guard interval, in which a signal assigned to some bands for one symbol and a signal assigned to the other bands have different sized guard intervals.

Further still another object of the present invention is to provide a method and apparatus for increasing efficiency of a mobile communication system.

To achieve these objects and other advantages and in accordance with the purpose of the invention, as embodied and broadly described herein, one feature of the present invention is characterized in that a guard interval which includes at least one of cyclic prefix and cyclic postfix is generated using phase rotation. In other words, after a phase of a symbol to be transmitted from a transmitting side of a communication system to its receiving side is rotated and the symbol is converted into a time-domain symbol, at least one of the cyclic prefix and the cyclic postfix is inserted to generate a final guard interval.

In one aspect of the present invention, a method for inserting a guard interval in an OFDM or OFDMA mobile communication system comprises rotating a phase of each symbol for a specific symbol stream, converting the phase-rotated symbol stream into a time-domain symbol stream, and performing at least one of copying a rear part of the time-domain symbol stream to insert the rear part of the time-domain symbol stream to the front of the time-domain symbol stream and copying a front part of the time-domain symbol stream to insert the front part of the time-domain symbol stream to the end of the time-domain symbol stream.

In another aspect of the present invention, a method for inserting a guard interval to a plurality of OFDM symbols in an OFDM or OFDMA mobile communication system comprises a first step of inserting a cyclic prefix and a cyclic postfix to an OFDM symbol of the plurality of OFDM symbols and a second step of inserting any one of the cyclic prefix and the cyclic postfix to the other OFDM symbols of the plurality of OFDM symbols.

In still another aspect of the present invention, a method for inserting a guard interval to a specific OFDM symbol of a plurality of OFDM symbols in an OFDM or OFDMA mobile communication system comprises rotating a phase of each frequency-domain symbol which is to constitute the specific OFDM symbol, converting the phase-rotated symbol stream into time-domain signals to generate the specific OFDM symbol, and copying a rear part or a front part of the specific OFDM symbol to respectively insert the rear part or the front part of the specific OFDM symbol to the front or the end of the OFDM symbol.

In further still another aspect of the present invention, a method for inserting a guard interval in an OFDM or OFDMA mobile communication system comprises rotating a phase of each symbol for a part of a symbol stream, the part of the symbol stream being assigned to a part of a whole band, assigning the symbol stream to the whole band to convert the symbol stream into time-domain symbols, and copying a rear part or a front part of the time-domain symbols to respectively insert the rear part or the front part to the front or the end of the time-domain symbols.

In further still another aspect of the present invention, a transmitter in an OFDM or OFDMA mobile communication system comprises a phase rotation module rotating a phase of each symbol for at least a part of a symbol stream, a frequency-time conversion module converting the symbol stream into time-domain symbols, the symbol streams including the part of the symbol stream phase-rotated by the phase rotation module, and a guard interval insertion module either copying a rear part of the time-domain symbols to insert the rear part to the front of the time-domain symbols or copying a front part of the time-domain symbols to insert the front part to the end of the time-domain symbols.

### BRIEF DESCRIPTION OF THE DRAWINGS

FIG. 1 is a diagram illustrating a method of inserting cyclic prefix and cyclic postfix in case where both the cyclic prefix and the cyclic postfix are used in accordance with a related art;

FIG. 2 is a diagram for describing a basic concept of the present invention;

FIGS. 3A and 3B are block diagrams illustrating transmitters according to the preferred embodiments of the present invention;

FIG. 4 is a diagram illustrating another preferred embodiment of the present invention; and

FIG. 5 to FIG. 7 are diagrams illustrating another preferred embodiment of the present invention.

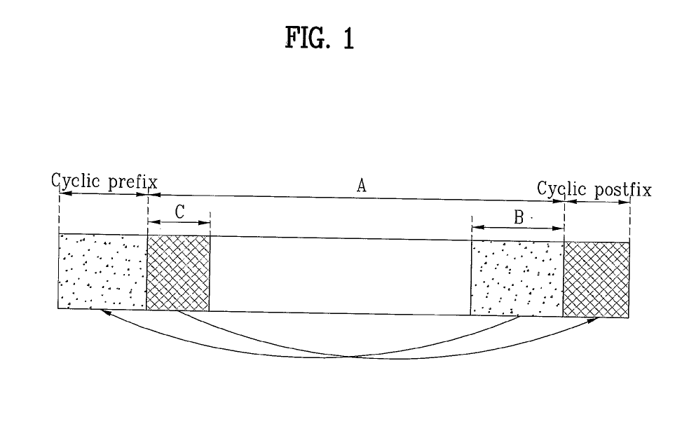

### BEST MODE FOR CARRYING OUT THE INVENTION

Hereinafter, structures, operations, and other features of the present invention will be understood readily by the preferred embodiments of the present invention, examples of which are illustrated in the accompanying drawings.

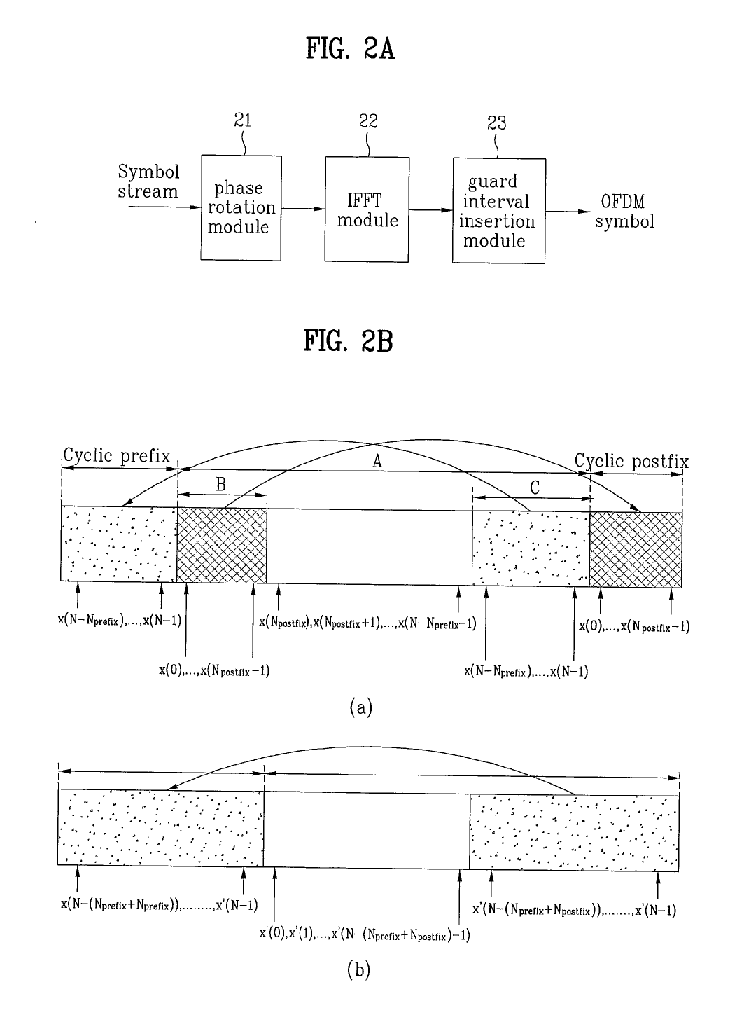

FIG. 2 is a diagram illustrating a basic concept of the present invention, wherein FIG. 2(a) illustrates a method for inserting cyclic prefix and cyclic postfix according to the related art, and FIG. 2(b) illustrates a method for inserting cyclic prefix and cyclic postfix according to the preferred embodiment of the present invention.

In FIG. 2(a), a part ‘A’ represents a portion where a data stream to be transmitted is converted into a time-domain symbol stream by IFFT. The cyclic prefix is generated in such a manner that a rear part ‘C’ of the time-domain symbol stream of the part ‘A’ is copied and inserted at the front of the part ‘A.’ The cyclic postfix is generated in such a manner that a front part ‘B’ of the part ‘A’ is copied and arranged at the rear of the part ‘A.’

Referring to FIG. 2(b), after a phase of each symbol to be transmitted is rotated before the symbol is converted into a time-domain symbol, a rear part having the same size as that obtained by adding the part ‘C’ to the cyclic postfix part in FIG. 2(a) for the time-domain symbol is copied and inserted in front of the time-domain symbol stream, so that cyclic prefix and cyclic postfix which are equivalent to those of FIG. 2(a) are inserted.

In order that final OFDM symbols shown in FIGS. 2(a) and 2(b) are equal to each other, a frequency-domain symbol X′(k) of x′(n) in FIG. 2(b) should perform phase rotation of a frequency-domain symbol X(k) of X(n) in FIG. 2(a) as much as

$${e}^{j \frac{2 π}{N} {N}_{postfix}} .$$

This will now be described with reference to numerical expressions.

In FIGS. 2(a) and 2(b), x(n) and x′(n) (n=0, 1, . . . , N−1) respectively represent time axis samples generated by IFFT of transmission data symbols X(k) and X′(k) in FIGS. 2(a) and 2(b). The cyclic prefix and the cyclic postfix are respectively inserted to x(n) and x′(n) as shown in FIG. 2(a), and the cyclic prefix is only inserted thereto as shown in FIG. 2(b), whereby two OFDM symbols are finally generated. The final OFDM symbols should be equal to each other. Supposing that samples of the same indexes of the final OFDM symbols are x(N_{postfix}+τ), x′(τ), in order that the samples obtain the same value, the following equation 1 should be satisfied.

$$x ( {N}_{postfix} + τ ) = {x}^{′} ( τ ) \\ x ( {N}_{postfix} + τ ) = \frac{1}{\sqrt{N}} {\sum }_{k = 0}^{N - 1} X ( k ) {e}^{j \frac{2 π k}{N} ( {N}_{postfix} + τ )} \\ {x}^{′} ( τ ) = \frac{1}{\sqrt{N}} {\sum }_{k = 0}^{N - 1} {X}^{′} ( k ) {e}^{j \frac{2 π k}{N} τ} \\ \begin{matrix}{X}^{′} ( k ) {e}^{j \frac{2 π k}{N} τ} = X ( k ) {e}^{j \frac{2 π k}{N} ( {N}_{postfix} + τ )} \\ = X ( k ) {e}^{j \frac{2 π k}{N} τ} {e}^{j \frac{2 π k}{N} {N}_{postfix}}\end{matrix} \\ {X}^{′} ( k ) = X ( k ) {e}^{j \frac{2 π k}{N} {N}_{postfix}} \qquad [ Equation 1 ]$$

The result of the equation 1 means that the same signal as when the cyclic prefix and the cyclic postfix are respectively used in accordance with FIG. 2(a) can be generated if the sum (the sum of the part ‘C’ and the cyclic postfix part in FIG. 2(a)) of the cyclic prefix and the cyclic postfix is copied from a rear part of the symbol and arranged at the front of the symbol after IFFT is performed by substitution of

$$X ( k ) {e}^{j \frac{2 π k}{N} {N}_{postfix}}$$

for X′(k) i.e. substitution of a phase-rotated value as much as

$${e}^{j \frac{2 π k}{N} {N}_{postfix}}$$

for data X(k) to be transmitted.

Referring to FIG. 2(b), the cyclic prefix is used after phase rotation so as to obtain the same effect as when the cyclic prefix and the cyclic postfix are inserted. As another example, the cyclic postfix may only be used after phase rotation, so as to obtain the same effect as when two cyclic extension methods are used. In this case, a value of phase rotation performed before IFFT should be equal to

$${e}^{- j \frac{2 π k}{N} {N}_{prefix}} .$$

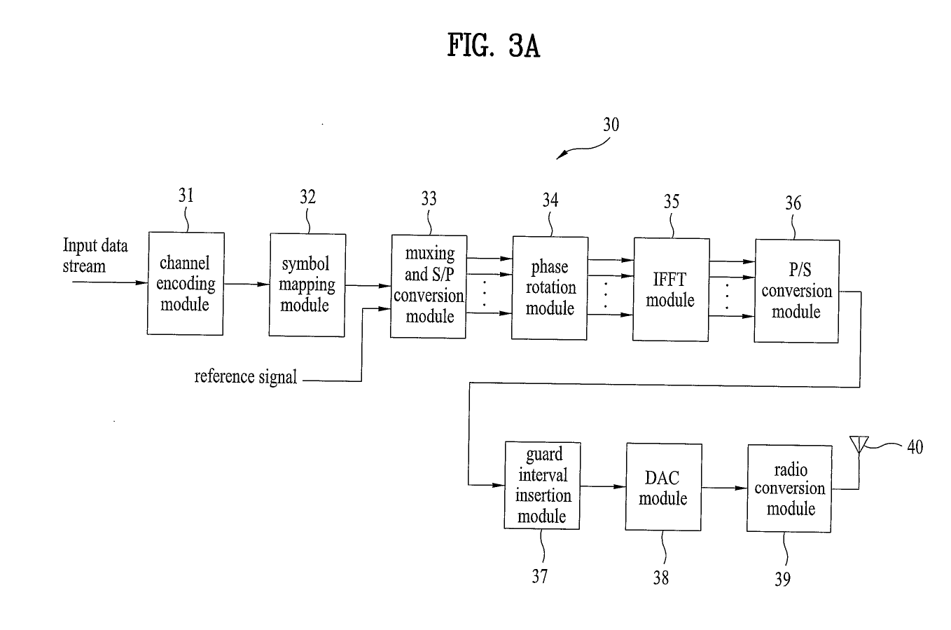

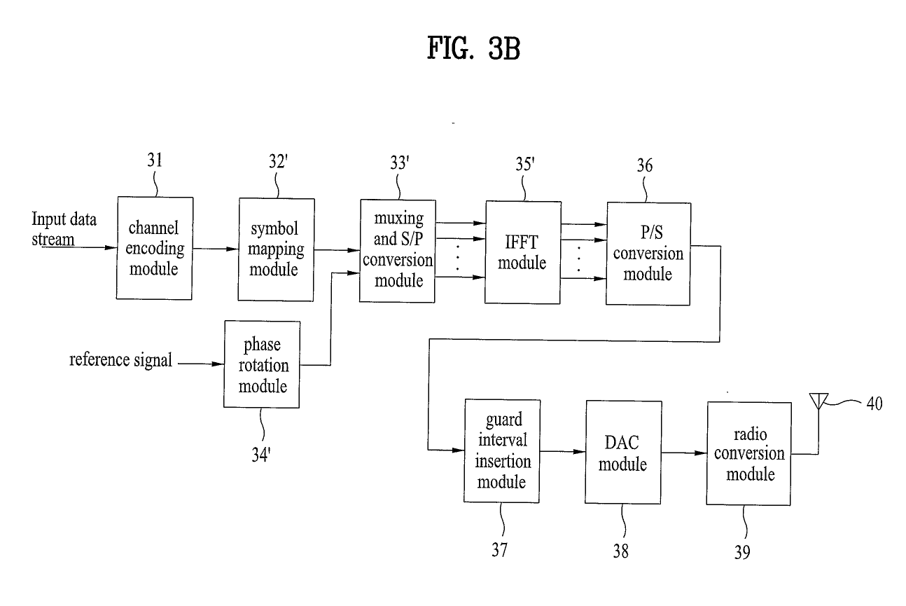

FIG. 3A is a block diagram illustrating a transmitter 30 according to the preferred embodiment of the present invention. The transmitter 30 includes a channel encoding module 31 performing channel encoding for an input data stream, a symbol mapping module 32 performing digital modulation for the data stream channel encoded by the channel encoding module 31 and performing symbol mapping for the digital modulated data stream, a muxing and S/P conversion module 33 multiplexing a symbol stream output from the symbol mapping module 32 and a reference signal sequence input separately from the symbol stream and converting the multiplexed result into a parallel symbol stream, a phase rotation module 34 rotating a phase of each symbol for the parallel symbol stream output from the muxing and S/P conversion module 33, an IFFT module 35 converting the symbol stream phase-rotated by the phase rotation module 34 into a time-domain symbol stream through IFFT, a P/S conversion module 36 converting the parallel signal output from the IFFT module 35 into a serial signal, a guard interval insertion module 37 inserting a guard interval to the time-domain symbol stream output from the P/S conversion module 36, a DAC module 38 converting the symbol output from the guard interval insertion module 37 into an analog signal, a radio modulation module 39 modulating the signal output from the DAC module 38 by using high frequency, and an antenna 40 transmitting the signal output from the radio modulation module 39.

Channel encoding performed by the channel encoding module 31 is to allow a transmitting side to add an optional signal previously agreed between the transmitting side and a receiving side, thereby detecting an error that may occur during transmission due to noise and interference on a transmission channel and recovering a damaged signal. Channel decoding corresponds to an inverse step of the channel encoding and is to allow the receiving side to recover original data from the channel encoded data received from the transmitting side. Examples of a channel encoding and decoding method widely used in a communication system include convolutional coding, turbo coding, and low density parity check (LDPC) coding, etc.

The symbol mapping module 32 performs symbol mapping by performing digital modulation for the data stream output by the channel encoding module 31. The digital modulation is to map at least two or more bits with one symbol. Examples of the digital modulation method include, but not limited to, binary phase shift keying (BPSK), quadrature phase shift keying (QPSK), 16-QAM (quandrature amplitude modulation), 64-QAM, and 256-QAM, etc.

The muxing and S/P conversion module 33 performs multiplexing of the symbol stream output from the symbol mapping module 32 and the reference signal sequence input separately from the symbol stream and converts the multiplexed result into the parallel symbol stream. The reference signal sequence means a signal such as a pilot signal used for initial synchronization, acquisition of time and frequency synchronization, channel estimation, etc. in the communication system. Examples of the reference signal mainly used in the communication system include a binary sequence code such as Hadamard code and a poly-phase code such as CAZAC code. FIG. 3A illustrates a system corresponding to a case where a complex code having a phase, like CAZAC code, is used as a reference signal. In this case, the complex code sequence is multiplexed with the symbol sequence output from the symbol mapping module 32.

The phase rotation module 34 rotates the phase of the parallel symbols output from the muxing and S/P conversion module 33. The phase of each symbol can be rotated in such a manner that each symbol is multiplied by

$${e}^{j \frac{2 π k}{N} {N}_{postfix}}$$

$$or$$

$${e}^{- j \frac{2 π k}{N} {N}_{prefix}} .$$

The phase rotation module 34 may perform phase rotation depending on the purpose of the system. Namely, the phase rotation module 34 may perform phase rotation for the whole symbols which are assigned to sub-carriers of the whole bands by IFFT to form one OFDM symbol. Alternatively, the phase rotation module 34 may perform phase rotation for a part of the whole symbols which are assigned to sub-carriers of a part of the whole bands. Furthermore, the phase rotation module 34 may perform phase rotation for the purpose of inserting the cyclic prefix and the cyclic postfix to one OFDM symbol in a radio frame constituted by a plurality of OFDM symbols. This phase rotation will be described later in detail.

The IFFT module 35 performs IFFT (inverse fast fourier transform) for the parallel symbol stream output from the phase rotation module 34 to convert the parallel symbol stream into time-domain symbols. The P/S conversion module 36 converts the symbols converted by the IFFT module 35 into serial symbols.

The guard interval insertion module 37 generates the guard interval by inserting the cyclic prefix or the cyclic postfix to the symbols output from the P/S conversion module 36. In this case, the method for inserting the cyclic prefix or the cyclic postfix is the same as that described in detail with reference to FIG. 2(b). In other words, in the case that the phase rotation module 34 performs phase rotation as much as

$${e}^{j \frac{2 π k}{N} {N}_{postfix}} ,$$

the guard interval insertion module 37 copies a rear part of the symbols and inserts the copied rear part at the front of the symbols. In the case that the phase rotation module 34 performs phase rotation as much as

$${e}^{- j \frac{2 π k}{N} {N}_{prefix}} ,$$

the guard interval insertion module 37 copies a front part of the symbols and inserts the copied front part at the rear of the symbols. As a result, the same effect as when the cyclic prefix and the cyclic postfix are inserted as shown in FIG. 2(a) can be obtained.

The symbol stream to which the guard interval is inserted by the guard interval insertion module 37 is converted into analog signals by the DAC module 38, and is modulated by the high frequency in the radio modulation module 39. Afterwards, the symbol streams are power-amplified by a power amplifier (not shown) and then transmitted to the receiving side through the antenna 40.

FIG. 3B is a block diagram according to another preferred embodiment of the present invention. In other words, in the embodiment of FIG. 3B, a position of a phase rotation module 34′ has been shifted in comparison with the embodiment of FIG. 3A. The phase rotation module 34′ rotates a phase of each of a reference signal sequence and outputs the phase-rotated reference signal sequence, and a muxing and S/P conversion module 33′ multiplexes the symbols output from the symbol mapping module 32′ and the phase-rotated reference signal and converts the multiplexed symbols into parallel symbols. The other modules are the same as those described with reference to FIG. 3A. The embodiment of FIG. 3B will be useful when different guard intervals are inserted to the reference signal and transmission data in view of size and form. For example, when both the cyclic prefix and the cyclic postfix are inserted to the reference signal while either the cyclic prefix or the cyclic postfix is inserted to the data symbols, the embodiment of FIG. 3B will be used. Examples of the reference signal include a pilot signal and a preamble. The reference signal may be replaced with a synchronization channel (SCH). By contrast, phase rotation may not be performed for the reference signal but be performed for the data symbols.

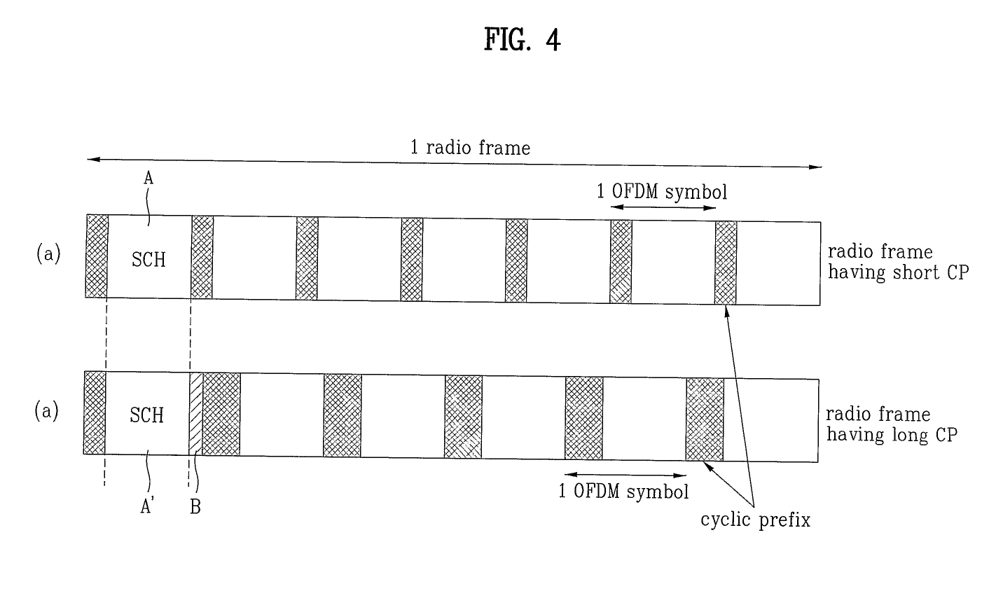

FIG. 4 is a diagram illustrating another preferred embodiment of the present invention. FIG. 4 relates to an embodiment to which technical features of the present invention are applied in order that the cyclic prefixes of the first OFDM symbol to which the SCH is transmitted have the same length in an OFDM or OFDMA communication system which uses the cyclic prefix having different lengths as the case may be.

In a communication system which transmits a plurality of OFDM symbols through a radio frame, it is necessary to use cyclic prefixes having different lengths for the respective OFDM symbols. Generally, if the cyclic prefix becomes long, the OFDM symbols are well protected from inter-symbol interference (ISI), whereby receiving quality may be improved. However, if the cyclic prefix becomes too long, unnecessary overhead increases. This may lead to undesirable communication efficiency.

Accordingly, the system should control the length of the cyclic prefix to improve receiving quality or communication efficiency. For example, cyclic prefixes having different lengths may be used in such a manner that a mobile terminal located at a boundary part of a cell is distinguished from a mobile terminal not located at the boundary part of the cell, thereby transmitting the OFDM symbols. Also, the cyclic prefixes having different lengths may be used depending on whether transmission data are multicast/broadcast data or unicast data, thereby transmitting the OFDM symbols. In FIG. 4, (a) illustrates an example of a radio frame where a short cyclic prefix is used, and (b) illustrates an example of a radio frame where a long cyclic prefix is used except for the first OFDM symbol.

However, in the case that the cyclic prefixes having different lengths are used, a problem occurs in that the receiving side should previously know information of a transmission format or should previously be informed of the information of the transmission format due to different lengths of the cyclic prefixes in a method of transmitting and receiving initial synchronization and control information. To solve such a problem, a specific OFDM symbol of a specific radio frame or all the radio frames, for example, the first OFDM symbol may be transmitted with a cyclic prefix having the same length, and the other OFDM symbols may be transmitted with cyclic prefixes having different lengths depending on the radio frames.

At this time, information is transmitted through the first OFDM symbol of each radio frame, wherein the information can classify the lengths of the cyclic prefixes for the other OFDM symbols of the radio frame. Then, the mobile terminal can identify the lengths of the cyclic prefixes for the other OFDM symbols of a corresponding radio frame by receiving the first OFDM symbol having the cyclic prefixes of the same length from each radio frame.

If the mobile terminal does not be informed of a length of a cyclic prefix of an OFDM symbol transmitted during a radio frame in advance, the mobile terminal cannot demodulate control information included in the radio frame as well as data. Accordingly, it is preferable that the mobile terminal exactly receives the first OFDM symbol of the radio frame by using a cyclic prefix having a length which is previously determined. Furthermore, the length of the cyclic prefix for the other OFDM symbols may be indicated by control information transmitted through the first OFDM symbol. After all, since the first OFDM symbol for each radio frame is transmitted by the cyclic prefix of the previously determined length, the mobile terminal can exactly receive the first OFDM symbol. The mobile terminal can exactly receive the other OFDM symbols by using information of the length of the cyclic prefix acquired through the control information included in the first OFDM symbol.

Referring to FIG. 4, the OFDM symbols through which synchronization channels A and A′ transmitted for downlink initial synchronization are transmitted by the cyclic prefix of the previously determined length regardless of the length of the cyclic prefix for the other OFDM symbols transmitted within a corresponding radio frame. In this way, the mobile terminal supposes synchronization channels of the same format regardless of a transmission format of a radio frame from which the synchronization channels are transmitted, and detects the synchronization channels to establish initial synchronization. Furthermore, the synchronization channels or control channels transmitted through the OFDM symbols like the synchronization channels may include length information of the cyclic prefix used in the other OFDM symbols of the current radio frame.

As described above, in the case that only a specific OFDM symbol has the cyclic prefix of the same length at different transmission formats, a gap of a transmission signal occurs in the specific symbol as much as the length of the cyclic prefix, which is reduced from the length of the existing cyclic prefix, due to the transmission format having cyclic prefixes of different lengths. In this case, the cyclic postfix equivalent to the gap can be used. If the cyclic postfix is used, the same effect as when the long cyclic prefix is used can be obtained. In other words, if the cyclic postfix is used as much as the reduced length of the cyclic prefix, quality of receiving signals can be improved in the same manner as when the existing long cyclic prefix is used. Moreover, a problem caused by the transmission format having cyclic prefixes of different lengths can be solved.

However, if the above method is used, there coexist, within one radio frame, the OFDM symbols corresponding to the case where both the cyclic prefix and the cyclic postfix are used and the OFDM symbols corresponding to the case where the cyclic prefix is only used. In this case, after phase rotation

$${e}^{j \frac{2 π k}{N} {N}_{postfix}}$$

equivalent to the cyclic postfix part B is performed for the symbol stream constituting the SCH to be transmitted before IFFT is performed for the specific symbol (first symbol which transmits the SCH in FIG. 4) in accordance with the technical features of the present invention, IFFT is performed to generate the OFDM symbols so that a rear part of the OFDM symbols equivalent to the copied length for insertion of the cyclic prefix for the other OFDM symbols within a corresponding radio frame and is arranged at the front of the OFDM symbols. In this way, the same effect as when the cyclic prefix and the cyclic postfix coexist can be obtained.

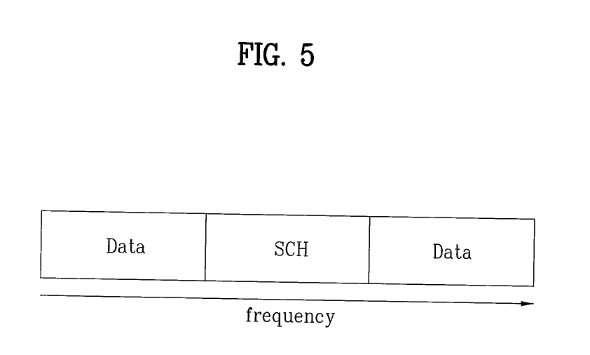

FIG. 5 to FIG. 7 are diagrams illustrating another preferred embodiments of the present invention, and relate to the embodiments where a part of the whole frequency bands are only assigned for transmission of the synchronization channel (SCH) and data are transmitted through the other bands.

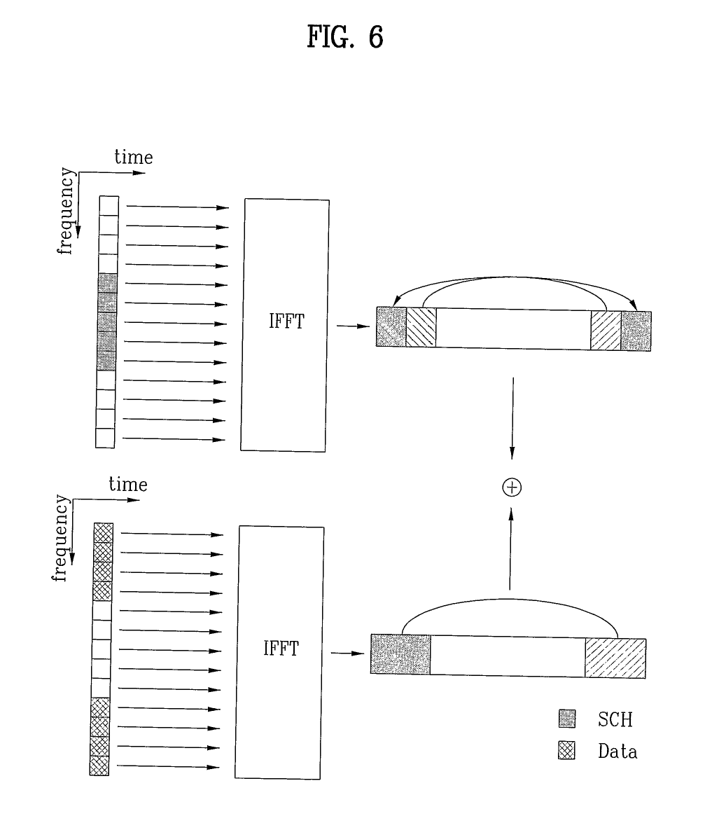

In the case that both the short cyclic prefix and the cyclic postfix are used for the synchronization channel and the long cyclic prefix corresponding to the existing transmission format is used for data as described in the embodiment of FIG. 4, according to the related art, after IFFT is performed respectively for the synchronization channel and the data part as shown in FIG. 6, the short cyclic prefix and the cyclic postfix are used for the synchronization channel while the long cyclic prefix is used for the data part. After the synchronization channel and the data part are cyclically extended separately, their signals are joined together.

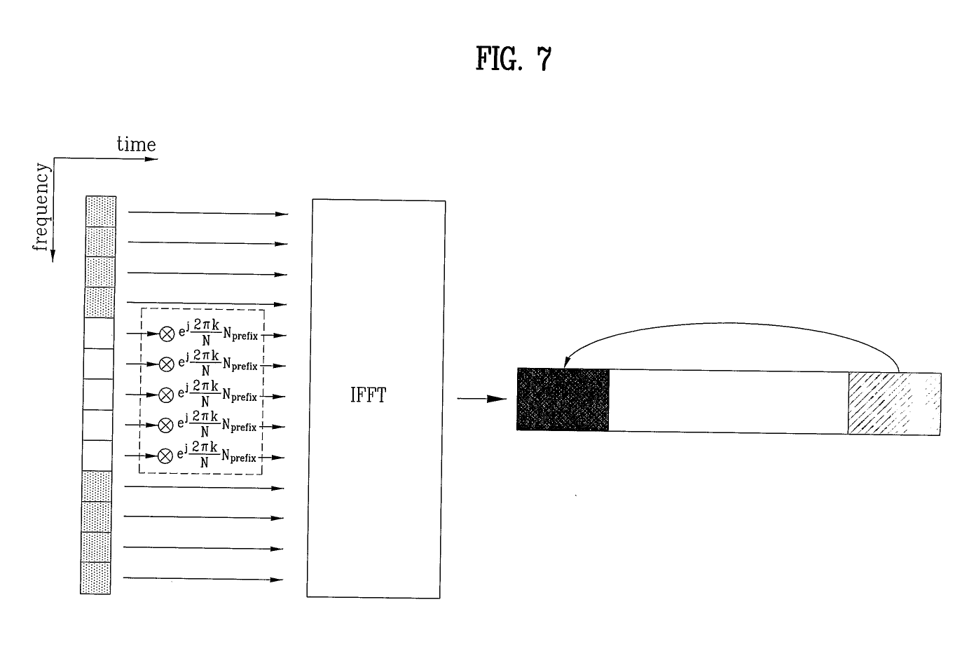

However, as shown in FIG. 7, in the case that the technical features according to the present invention are used, phase rotation is performed for the part corresponding to the synchronization channel and then IFFT is performed for the synchronization channel along with the data part to generate the symbols. Then, the rear part of the generated symbols is copied as much as the long cyclic prefix and arranged in front of the symbols. Thus, it is possible to at once generate the same OFDM symbols as when the cyclic prefix and the cyclic postfix are used for the synchronization channel while the long cyclic prefix is used for the data part. In this way, if the technical features according to the present invention are used as above, IFFT is performed only one time, whereby complexity and signal processing time can be reduced. Alternatively, after phase rotation is performed for the data part not the synchronization channel and IFFT is performed for the synchronization channel and the data part, the same signal as above may be generated using the cyclic prefix and the cyclic postfix.

Furthermore, although the example of the synchronization channel has been described in the aforementioned embodiments, other channels (for example, pilot channels which transmit pilot signals) not the synchronization channel may be used if they are transmitted at the same structure as that of the synchronization channel.

The technical features of the present invention can be applied to a DFT-S-OFDM system. The DFT-S-OFDM system is also referred to as a single carrier-FDMA (SC-FDMA) system. The SC-FDMA system is mainly applied to an uplink, and performs spreading by using a DFT matrix in a frequency-domain before generating OFDM signals and then modulates the resultant signals in an existing OFDM mode to transmit them. If the technical features of the present invention are applied to the DFT-S-OFDM system, phase rotation may be performed before or after spreading by means of the DFT matrix is performed.

As another embodiment of the present invention, the present invention may be applied to all the cases where the cyclic prefix and the cyclic postfix are used, so that only one of the cyclic prefix and cyclic postfix may be used to generate the same signal as when both the cyclic prefix and the cyclic postfix are used. On the other hand, both the cyclic prefix and the cyclic postfix may be used, so that the same signals as when only one of the cyclic prefix and the cyclic postfix is used may be generated. Furthermore, the present invention may be applied to all the cases where additional cyclic postfix or additional cyclic prefix is required as different cyclic prefixes or different cyclic postfixes are used among different resources assigned within one OFDM symbol.

According to the present invention, the following advantages can be obtained.

First, the guard interval which includes any one of the cyclic prefix and the cyclic postfix can be inserted by the method which is simpler and more efficient than the related art method.

Second, the radio frame which includes a plurality of different symbols of which guard intervals have different sizes can be generated readily.

Finally, the size of the guard band of the signals assigned to some bands can differ from the size of the guard band of the signals assigned to the other bands while complexity and signal processing time for one symbol are being reduced.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

### INDUSTRIAL APPLICABILITY

The present invention can be applied to a wireless communication system such as a wireless Internet system and a mobile communication system.

1. A method for inserting a guard interval in an OFDM or OFDMA mobile communication system, the method comprising:
rotating a phase of each symbol for a specific symbol stream;
converting the phase-rotated symbol stream into a time-domain symbol stream; and
performing at least one of copying a rear part of the time-domain symbol stream to insert the rear part of the time-domain symbol stream to the front of the time-domain symbol stream and copying a front part of the time-domain symbol stream to insert the front part of the time-domain symbol stream to the end of the time-domain symbol stream.

2. The method of claim 1, wherein the specific symbol stream is a reference signal sequence.

3. The method of claim 1, wherein the specific symbol stream is a pilot signal sequence.

4. The method of claim 1, wherein the specific symbol stream is obtained by symbol mapping for an input binary data stream.

5. The method of claim 1, wherein the phase of each symbol is rotated at the same value.

6. The method of claim 2, wherein the reference signal sequence is a CAZAC sequence.

7. A method for inserting a guard interval to a plurality of OFDM symbols in an OFDM or OFDMA mobile communication system, the method comprising:
a first step of inserting a cyclic prefix and a cyclic postfix to an OFDM symbol of the plurality of OFDM symbols; and
a second step of inserting any one of the cyclic prefix and the cyclic postfix to the other OFDM symbols of the plurality of OFDM symbols.

8. The method of claim 7, wherein the plurality of OFDM symbols are OFDM symbols constituting a single radio frame.

9. The method of claim 7, wherein the first step includes:
rotating a phase of each frequency-domain symbol which is to constitute the OFDM symbol;
generating the OFDM symbol by converting the phase rotated symbol stream into time-domain signals; and
copying a rear part or a front part of the OFDM symbol to insert the rear part or the front part of the OFDM symbol to the front or the end of the OFDM symbol, respectively.

10. The method of claim 7, wherein the OFDM symbol is an OFDM symbol for transmission of synchronization channels (SCH).

11. The method of claim 9, wherein the phase of each frequency-domain symbol is rotated as much as a cyclic postfix part which is finally generated.

12. The method of claim 11, wherein the rear part inserted to the front of the OFDM symbol has the same size as that of a rear part copied to insert the cyclic prefix for the other OFDM symbols.

13. A method for inserting a guard interval to a specific OFDM symbol of a plurality of OFDM symbols in an OFDM or OFDMA mobile communication system, the method comprising:
rotating a phase of each frequency-domain symbol which is to constitute the specific OFDM symbol;
converting the phase-rotated symbol stream into time-domain signals to generate the specific OFDM symbol; and
copying a rear part or a front part of the specific OFDM symbol to respectively insert the rear part or the front part of the specific OFDM symbol to the front or the end of the OFDM symbol.

14. The method of claim 13, wherein any one of a cyclic prefix and a cyclic postfix is inserted to the other OFDM symbols except for the specific OFDM symbol.

15. The method of claim 14, wherein a final cyclic prefix inserted to the specific OFDM symbol has a length different from that of a cyclic prefix inserted to the other OFDM symbols.

16. The method of claim 15, wherein the plurality of OFDM symbols are OFDM symbols constituting a first radio frame.

17. The method of claim 16, wherein the guard interval is generated in such a manner that a cyclic prefix having the same size as that of the cyclic prefix inserted to the other OFDM symbols is inserted to all the OFDM symbols constituting a second radio frame.

18. A method for inserting a guard interval in an OFDM or OFDMA mobile communication system, the method comprising:
rotating a phase of each symbol for a part of a symbol stream, the part of the symbol stream being assigned to a part of a whole band;
assigning the symbol stream to the whole band to convert the symbol stream into time-domain symbols; and
copying a rear part or a front part of the time-domain symbols to respectively insert the rear part or the front part to the front or the end of the time-domain symbols.

19. The method of claim 18, wherein the part of the whole band is a band to which a synchronization channel (SCH) is assigned.

20. A transmitting apparatus in an OFDM or OFDMA mobile communication system, the transmitting apparatus comprising:
a phase rotation module rotating a phase of each symbol for at least a part of a symbol stream;
a frequency-time conversion module converting the symbol stream into time-domain symbols, the symbol streams including the part of the symbol stream phase-rotated by the phase rotation module; and
a guard interval insertion module either copying a rear part of the time-domain symbols to insert the rear part to the front of the time-domain symbols or copying a front part of the time-domain symbols to insert the front part to the end of the time-domain symbols.
